(19) United States
(12) Patent Application Publication
(10) Pub. No.: US 2015/0272100 A1
(43) Pub. Date: Oct. 1, 2015

(54) Grip for Fishing Rod Handle

(71) Applicant: Michael William Bournique, Wales, MA (US)

(72) Inventor: Michael William Bournique, Wales, MA (US)

(21) Appl. No.: 14/666,910

(22) Filed: Mar. 24, 2015

Related U.S. Application Data
(60) Provisional application No. 61/972,079, filed on Mar. 28, 2014.

(51) Int. Cl. A01K 87/08; A01K 91/00; A01K 97/00; A01K 87/02; A01K 87/00; A01K 87/04

(52) U.S. Cl. CPC A01K 87/08; A01K 87/00; A01K 87/04; A01K 97/00; A01K 87/025; A01K 91/00

(57) ABSTRACT

A grip on a fishing pole forward of the reel, which provides additional leverage and avoids interference with the reel while playing a fish. The grip device has a vertically extended portion and an angled or horizontal grab bar portion, by which with an extended arm, the angler can firmly grip the angled or horizontal portion, palm down. With the palm down, a straight line of force can be applied from the fingers of the extended arm, through the arm, to the shoulder socket. This line of force is longer, straighter, and more direct than can be achieved with other equipment and techniques where the extended arm grasps the forward portion of the handle. Furthermore, the height of the grip is closer to the elevation of the angler's shoulder, which also maximizes the force that can be applied and clears the arm and hand from interference with the reel.

### RELATED APPLICATION

This application claims priority under 35 U.S.C. §119(e) of U.S. Provisional Application No. 61/972,079 filed Mar. 28, 2014 for “Clamp on Handle for Fishing Rods.”

### BACKGROUND

The present invention relates to fishing gear and particularly to supporting a medium to heavy weight fishing pole while reeling in a fish.

Equipment is known for providing support to an angler who has a relatively large fish in play. These generally provide a socket or the like into which the butt end of the pole handle can be secured while the angler has one hand on the forward portion on the handle and the other hand on the reel winder. Another form of assistance is a harness around the angler's torso with straps that connect to rings or the like on the reel. In this technique as well as the previous technique, one hand is around the forward portion of the handle while the other hand is operating the reel. In such known techniques, the angler must extend one arm alongside the reel, which is at an elevation between the angler's shoulder and the front portion of the handle. This negatively affects the maximum leverage that can applied by the extended arm, and can cause abrasion, discomfort, and even injury when playing several heavy fish on a given day.

### SUMMARY

It is an object of the present invention to provide a grip on the fishing pole forward of the reel, which provides additional leverage and avoids interference with the reel.

This object is achieved by clamping a grip member onto the rod, having a vertically extended portion and an angled or horizontal grab bar portion, by which with an extended arm, the angler can firmly grip the angled or horizontal portion, palm down.

With the palm down, a straight line of force can be applied from the fingers of the extended arm, through the arm, to the shoulder socket. This line of force is longer, straighter, and more direct than can be achieved with other equipment and techniques where the extended arm grasps the forward portion of the handle. Furthermore, the height of the grip is closer to the elevation of the angler's shoulder, which also maximizes the force that can be applied and clears the arm and hand from interference with the reel.

In one embodiment, a fishing pole assembly comprises a handle having a centerline; a tubular rode extending concentrically from the handle; reel attached to the handle and offset laterally to one side of the handle, wherein the reel includes a spool and a winder for rotation about a winder axis; a plurality of line guides attached to the rod and offset laterally to one side the rod, in operative alignment with the reel; and a grip device attached to the pole forward of the reel and extending transversely to the rod, including a grab bar portion that is offset from the pole and extends in a direction substantially parallel to the winding axis.

Preferably, the grip device includes a clamp portion attached to the handle or rod, a body that extends from the grip portion transversely to the pole and encircles a space bordered by the grab bar portion, whereby the grab bar can be manually grabbed by a hand with the palm of the hand facing the rod and the fingers of the hand in the space. Most preferably, the grab bar and space are defined by a D-ring extending from the clamp portion.

The grab bar and opening below the grab bar are preferably large enough to accommodate two hands, whereby the angler can exert maximum leverage pulling back ward and upward, along the centerline of the rod.

In an alternative embodiment the grip device is adjustable, whereby the distance between the grab bar and the butt end of the handle can be varied to suit the length of the angler's arm, or other preference.

Another embodiment is directed to the combination of a fishing pole or component and grip device as would be marketed or sold for later assembly, wherein the grip device comprises a clamp portion attachable to the handle or the rod, and a body extending from the clamp portion and defining a grab bar that can be manually grabbed by a human hand with the palm of the hand facing the clamp portion.

Yet another embodiment is directed to grip device for clamping onto a fishing pole, comprising a clamp portion attachable the handle or rod; and a body that extends from the clamp portion and defines a grab bar that can be manually grabbed by a human hand with the palm of the hand facing the clamp portion; wherein the body carries at least one docking element onto which a fish hook on the line of a rigged pole can be temporarily engaged while the angler carries the rod.

The grip device can take a variety of shapes as more fully described below.

### BRIEF DESCRIPTION OF THE DRAWING

FIG. 1 shows a schematic fishing pole with one embodiment of the inventive grip attached to the handle;

FIG. 2 is a detail view of the grip shown in FIG. 1;

FIG. 3 shows an “L” variation of the grip;

FIG. 4 shows an angled variation of the grip;

FIG. 5 shows a schematic representation of another embodiment of the grip by which the angle relative to the pole centerline can be adjusted; and

FIG. 6 shows the components that constitute the adjustment mechanism of FIG. 5.

### DETAILED DESCRIPTION

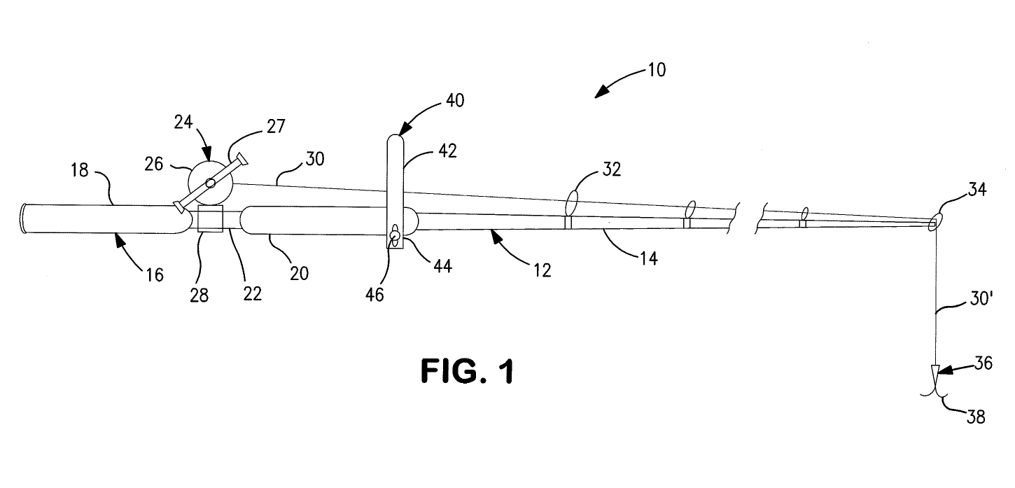

FIG. 1 shows fishing tackle or rigged pole 10 comprising an elongated, relatively flexible portion 12 in the form of a tubular rod 14 and a handle portion 16, which typically includes a rear portion 18, a forward portion 20, and an intermediate portion 22. A reel 24 is attached to the intermediate portion 22 and consists of a spool 26 with associated winding arms 27 and a bracket 28 or the like for attachment to the handle portion 22. A fishing line 30 extends from the reel 24 through a series of line guides 32 on the rod, to the tip guide 34 from which it has a free portion 30′ that extends from the rod and carries a lure or the like 36 having one or more hooks 38.

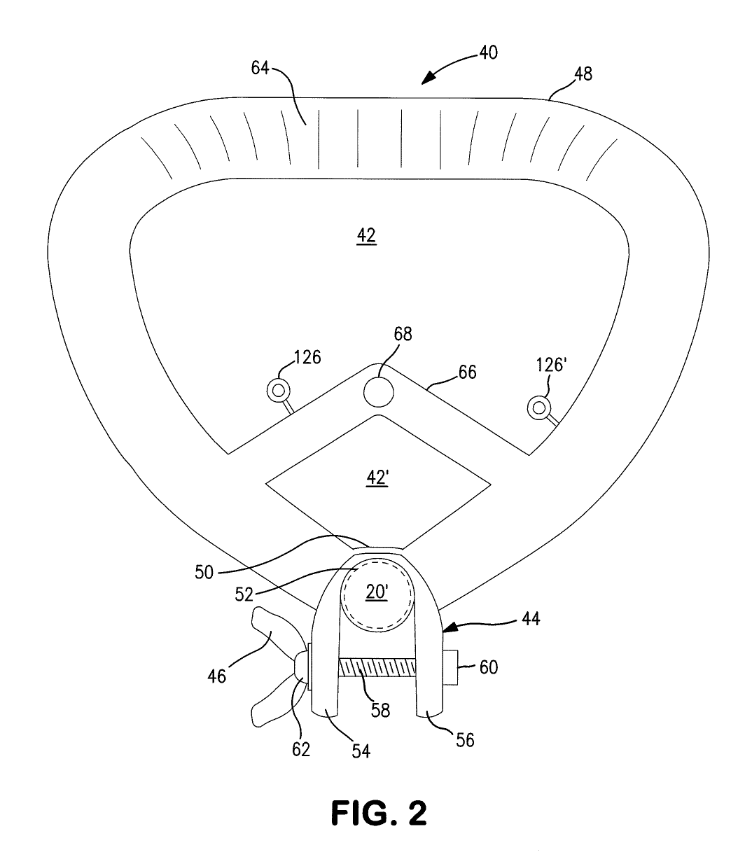

According to the present disclosure and with reference to FIGS. 1 and 2, a gripping device 40 generally functions as a grab bar, situated forward of the reel 24, on the handle portion 20 or rod 14. (Hereinafter, “pole” should be understood as referring to the combination of rod 14 and handle 16, whether or not the reel 24 is attached). The grip 40 defines an opening in the upper portion 42 and an attachment portion 44 which is typically actuated by wing nuts or the like 46, thereby securing the grip firmly to the pole. The line 30 passes through the substantially centrally open portion 42 whereas the upper portion of the device provides a grab-bar to be gripped with an extended arm as the angler plays a fish that has been hooked and is both pulling line and bending the rod.

The leverage for the angler is with the butt end of the back portion 18 of the handle set against the stomach, hip, or harness, with one hand operating the reel 24 and the other arm fully extended from the shoulder in a substantially straight line above the reel 24 to grasp the upper portion of the device 40, palm down, i.e., with the palm facing the rod.

The reel 24 includes a winder 27 that rotates about an axis that is perpendicular to the centerline of the pole. The winding axis is not necessarily the same as the spool rotation axis, which can be different for spinning reels than for bait casting reels. Another difference is that when the pole is held horizontally, a spinning reel and associated line guides are on the bottom of the pole, whereas with bait casting and similar reels 24, the reel and line guides 32, 34 are on the top of the pole. However, with any type of tackle set up, the clamp device 40 according to the present invention would be attached to the pole such that the outer, grab bar portion is situated above the top side of the pole, spaced by at least about four inches and preferably by at least six inches. This space is sufficient for a human hand to manually grab the bar with the palm of the hand facing the pole with the fingers fully curled over the bar and the thumb curled under the bar, into the space. This provides maximum contact area on the grab bar. With the center of the grab bar aligned above the centerline of the pole, the pulling force toward the shoulder is concentrated symmetrically upward on the grab bar, rather than partially along the side of the handle.

In the embodiment of FIG. 2, the device includes a substantially closed loop 48 defined by a rigid plastic ring of sturdy, preferably tubular or cylindrical cross section with converging portions that form a tubular web 50 that extends into the plane of the Figure and which cradles the upper surface of a portion 20′ of the pole (shown in phantom). The pole passes through space 52 defined by the web 50 and is clamped by the compression of wings 54, 56 that are squeezed together by turning wing nut 46, which advances along threaded bolt 58 held in place by nut 60. Preferably, a washer or grommet or the like 62 transmits the force of the wing nut 46 to wing 54.

The upper portion of the loop 48 defines a grab bar 64 which, in this case, extends symmetrically over the axis of the pole, perpendicularly to the pole. In the simplest embodiment, the entire space 42 encompassed by the loop 48 and upper surface of web 50, is available for the line to pass from the reel to the line guides. In a preferred embodiment, a cross member 66 spans opposed internal surfaces of the loop and carries either an internal hole 68 (or an attached ring, not shown) whereby the free portion 30′ of the line (see FIG. 1) can be turned back toward the reel, above the line guides 32 for capturing a hook 38 into hole 68. Conventionally, when an angler walks with the tackle 10 before or after deployment for fishing, the line 30′ is reversed and a hook secured either to a line guide 32 or to a soft or other receiving surface on the front portion of the handle 16. With the present invention, the hook is secured away from the handle, thereby avoiding potential accidental hooking of the fingers, and it also avoids damage to ceramic or other finely engineered line guides, and likewise avoids potential dulling of the hook against the rigid surface of a line guide.

In the embodiment shown in FIG. 2, the line could pass through the lower opening 42′, below the cross member 66, or the hole 68 could be used as a line guide.

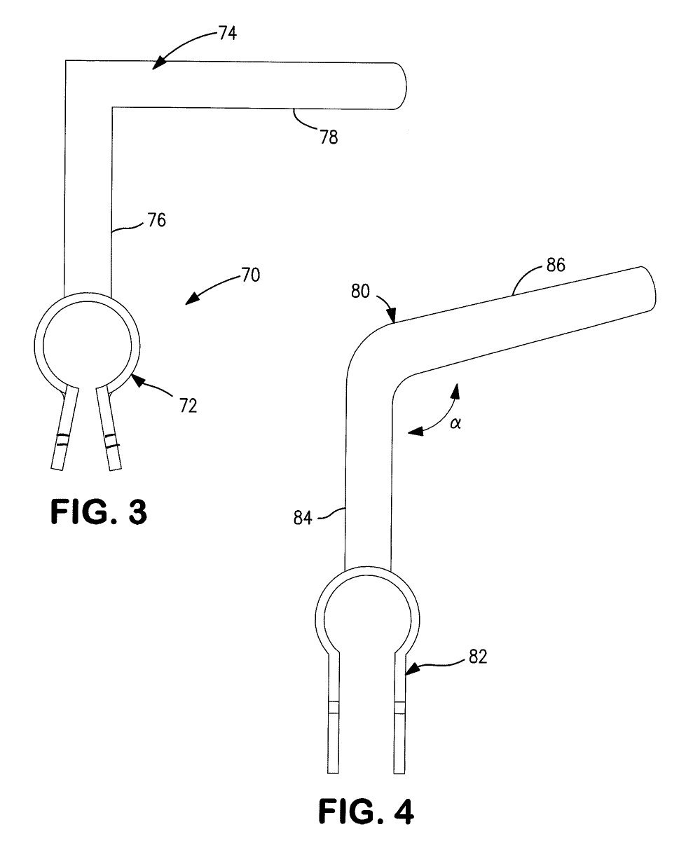

FIG. 3 shows another embodiment 70 having an attachment portion 72 and a riser portion 74, comprising a vertical member 76 and a horizontal grab bar 78 which together form an “L”. Alternatively, the grip device could be in the form of a “T” whereby the vertical member, grab bar member, and the angler's hand are symmetrically aligned with the centerline of the pole.

FIG. 4 shows yet another embodiment 80 that has an attachment portion 82 and a vertical portion 84 that are substantially similar to items 72 and 76 in FIG. 3, but the grab bar 86 is at an angle (a) to the horizontal, which would generally be within about 30°.

Both embodiments of FIGS. 3 and 4 provide the essential feature of a horizontal or nearly-horizontal grab bar portion by which the angler can firmly hold the bar with a straight arm and the palm facing substantially downward.

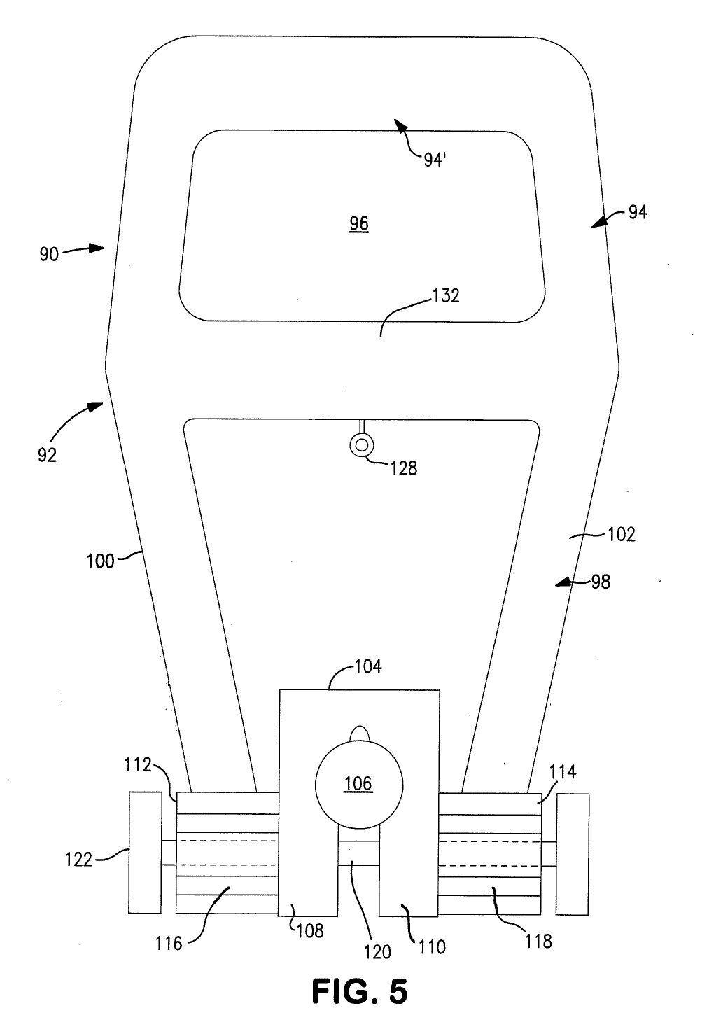

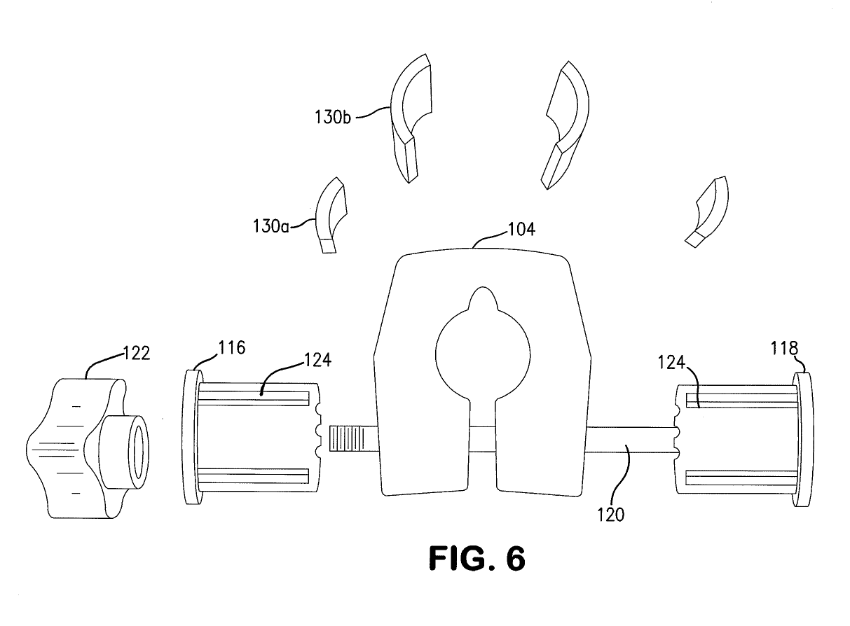

FIGS. 5 and 6 show another embodiment by which the angle of the device can be adjusted forward or backward. This device 90 has a body 92 including an upper portion 94 which defines an upper space 96 for receiving the fingers of the user as the grab bar 94′ at the top is grasped in the hand, and a lower portion 98 defined by drop legs 100 and 102. A mounting block 104 is situated between the lower ends of the legs, and defines a substantially circular opening 106 for receiving the pole, and legs 108, 110 which can be squeezed together in an analogous manner to that described with respect to FIG. 2 to secure the device to the pole. In this embodiment, the lower ends of the legs 108, 110 are formed as hollow bosses 112, 114, each of which receives a spindle 116, 118. The internal surface of the bosses and the external surfaces of the spindles are grooved and splined, whereby during assembly, the angle of the body 92 into and out of the plane of FIG. 5 can be adjusted. One of the splines such as 118 has a bolt 120 extending therefrom, to pass through a bore in the other spindle 116, for engaging a wing nut or the like 122.

FIG. 6 shows these components in disassembled fashion, including different sized shims 130a, 130b which can be selectively inserted into the opening 106 to better accommodate the varying diameters of different gage poles. The splines 124 on parts 116, 118 are also shown.

With reference again to FIG. 2 a docking element 126 or alternatively 126′ in the form of a ring is screwed into or otherwise carried by the body, onto which a fish hook 38 at the free end of the line can be engaged. In FIG. 2 the bore 68 through the cross member can serve as either a line guide or a docking element. If the bore is for a line guide, the docking element can be carried anywhere within the body, but preferably on the cross member 66, also shown as 128 on 132 in FIG. 5.

The embodiment of FIG. 5 can be characterized as the body including an inner end adjacent the clamp portion, an outer end defined by the grab bar portion 94′, opposed lateral members connected between the inner and outer ends of the body, and a cross member 132 spanning the lateral members. The main space 96 is an outer space defined by the grab bar portion, the cross member, and outer portions of the lateral members, and an inner space is defined by the cross member, the clamp portion, and inner portions of the lateral members.

1. A fishing pole assembly comprising:
a handle having a centerline;
a tubular rod extending concentrically from the handle;
a reel attached to the handle and offset laterally to one side of the handle, wherein the reel includes a spool and a winder for rotation about a winder axis
a plurality of line guides attached to the rod and offset laterally to one side the rod, in operative alignment with the reel; and
a grip device attached to the pole forward of the reel and extending transversely to the pole, including a grab bar portion that is offset from the pole and extends in a direction that is within 30 degrees of parallel to the winding axis.

2. The fishing pole assembly of claim 1, wherein the grip device includes a clamp portion attached to the pole, a body that extends from the clamp portion transversely to the pole, said body encircling a space bordered by the grab bar portion whereby the grab bar can be manually grabbed by a hand with the palm of the hand facing the pole and the fingers of the hand in said space.

3. The fishing pole assembly of claim 1, wherein the grip device includes at least one leg that projects transversely to the pole and said grab bar portion is rigidly supported by said at least one leg.

4. The fishing pole assembly of claim 1, wherein grip device is adjustably attached to the pole whereby the grab bar portion can be selectively adjusted within a range of positions toward and away from the reel.

5. The fishing pole assembly of claim 2, wherein said body includes a loop that defines said space which space extends from the clamp portion to the grab bar portion.

6. The fishing pole assembly of claim 2, wherein
said body includes an inner end adjacent the clamp portion, an outer end defined by said grab bar portion, opposed lateral members connected between the inner and outer ends of the body, and a cross member spanning the lateral members;
said space is an outer space defined by the grab bar portion, the cross member, and outer portions of the lateral members; and
an inner space is defined by said cross member, the clamp portion, and inner portions of the lateral members.

7. The fishing pole assembly of claim 6, including a hole at the cross member adapted to secure a fish hook.

8. The fishing pole assembly of claim 1, including fishing line running from the reel through the line guides to a free end at which a hook is attachable, and wherein said line passes through said space.

9. The fishing pole assembly of claim 1, wherein the grip device, reel, and line guides extend laterally on the same side of the pole, and the grab bar is offset from the pole a greater distance than the reel is offset from the handle.

10. The fishing pole assembly of claim 1, wherein the grab bar is offset from the pole by at least four inches, preferably at least six inches.

11. The fishing pole assembly of claim 1, wherein the grip device extends perpendicularly to the pole and the grab bar extends parallel to the winding axis.

12. The fishing pole assembly of claim 1, wherein the grip device includes a D-ring with the substantially straight side forming the grab bar and oriented parallel to the winding axis.

13. The fishing pole assembly of claim 1, wherein the grip device is a T-bar with the cross bar of the T forming said grab bar, oriented parallel to the winding axis.

14. The displayed combination of a fishing pole and grip device adapted to be secured to the pole, wherein
the pole comprises a handle portion and a rod portion; and
the grip device comprises a clamp portion attachable to the pole, and a body that extends from the clamp portion and defines a grab bar that can be manually grabbed by a human hand with the palm of the hand facing the clamp portion.

15. The combination of claim 14, wherein the grab bar is spaced at least four inches, preferably at least six inches, from the clamp portion.

16. A device for clamping onto a fishing pole, comprising:
a clamp portion attachable a fishing pole;
a body that extends from the clamp portion and defines a grab bar that can be manually grabbed by a human hand with the palm of the hand facing the clamp portion;
wherein said body carries at least one docking element onto which a fish hook can be engaged.

17. The device of claim 16, wherein said body includes,
an inner end adjacent the clamp portion, an outer end defined by said grab bar portion, opposed lateral members connected between the inner and outer ends of the body, and a cross member spanning the lateral members;
an outer space defined by the grab bar portion, the cross member, and outer portions of the lateral members;
an inner space defined by the cross member, the clamp portion, and inner portions of the lateral members; and
the docking element is situated on the cross member.

18. The device of claim 17, wherein the cross member includes a bore for guiding fishing line when the device is assembled with the fishing pole.
